(19) United States
(12) Patent Application Publication
(10) Pub. No.: US 2025/0358633 A1
(43) Pub. Date: Nov. 20, 2025

(54) SECURE xAPPs FOR A RADIO ACCESS NETWORK

(71) Applicant: Dell Products L.P., Round Rock, TX (US)

(72) Inventors: Omar Mohsen, Cairo (EG); Yassin Chaddad, New Cairo (EG)

(21) Appl. No.: 18/663,685

(22) Filed: May 14, 2024

(51) Int. Cl. H04W 16/18; H04L 41/0806; H04W 76/10

(52) U.S. Cl. CPC H04W 16/18; H04L 41/0806; H04W 76/10

(57) ABSTRACT

The described technology is generally directed towards securely onboarding, deploying, and implementing an xApp on a radio access network (RAN) network. Various embodiments are presented to enable a benign xApp to be utilized on a RAN while preventing a malicious xApp from being implemented. xApp parameters can be enforced to be in accordance with parameters known to be safe/secure. An xApp can be deployed via a RAN intelligent controller (RIC) rather than directly to a control plane of the container orchestration layer. Further, token validation can be utilized to ensure a known, securely configured xApp is attempting communication with a node rather than a malicious xApp. A token can comprise known information regarding the securely configured xApp, an associated container, and a node with which the xApp is attempting to establish communications.

### BACKGROUND

Radio access networks (RANs) provide wide-area wireless connectivity to mobile devices. A RAN can be constructed from devices manufactured by disparate vendors. Given the potentially vast scale and complexity of RANs developed to meet the ever-increasing demand for cellular communications, various vendor consortiums have been formed with a view to generating specifications to facilitate configurations, techniques, methods, equipment, etc., for respective communications on a RAN. Such consortiums include the Third Generation Partnership Project (3GPP) incorporating Long-Term Evolution Fourth Generation (LTE 4G), Fifth Generation/New Radio (5G, 5G/NR), and most recently, the Open-Radio Access Network (O-RAN).

An impetus of O-RAN is for an open, disaggregated RAN, which can be achieved by splitting the RAN architecture, applications (e.g., xApps, rApps), and protocols into different, independent components. Disaggregation is anticipated to reduce energy consumption, improve system performance, and allow for rapid, open innovation in different components while ensuring a multi-vendor, vendor agnostic, operability network.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to configure and implement secure xApps on a RAN. According to one or more embodiments, a system is presented, wherein the system comprises at least one processor, and at least one memory coupled to the at least one processor and having instructions stored thereon, wherein the system can be configured to securely onboard, deploy, and/or subscribe an application on a RAN. In response to the at least one processor executing the instructions, the instructions facilitate performance of operations, comprising receiving an application, wherein the application comprises a first parameter having a first setting, further comparing the first parameter with a secure schema, wherein the secure schema comprises a second parameter and a second setting that implements a security process absent from the first setting, and further, in response to determining that the first parameter and second parameter match, and that the first setting and second setting do not match, configuring the first parameter with the second setting. In an embodiment, the first parameter and the first setting can be included in descriptor content of the application. In another embodiment, the application can be a containerized application (xApp) deployable via network equipment of a radio access network (RAN). In an embodiment, the comparing is performed during onboarding of the application to the network equipment of the RAN.

In an embodiment, the operations can further comprise, in response to determining that the first parameter and the second parameter do not match, adding the second parameter to the application, and wherein the second parameter is added with the second setting.

In an embodiment, the operations can further comprise storing the descriptor content of the application and a container parameter defined for the application in a catalog, wherein the catalog comprises a set of applications, and wherein the set of applications have been previously compared with the secure schema.

In a further embodiment, the operations can further comprise deploying the application to a container orchestration layer (COL), further confirming that the application appears in the catalog, and in response to determining that the application does appear in the catalog, deploying the application to the COL, wherein deploying the application comprises creating a container at the COL, and wherein the container is configured based on the container parameter defined for the application. In another embodiment, operations can further comprise, in response to determining that the application does not appear in the catalog, denying deployment of the application to the COL. In a further embodiment, the operations further comprise capturing a container creation event at the COL, identifying an application creating the container event, further comparing the application with the catalog, and further, in response to the application being determined not to be in the catalog, denying deployment of the application.

In another embodiment, the operations can further comprise generating a token, wherein the token comprises first information identifying the application paired with second information identifying a node, wherein the application is attempting to establish communication with the node, further comparing the token with a runtime inventory, wherein the runtime inventory comprises a list of applications approved for deployment on the network equipment of the RAN, and further, in response to determining that the application and node paired in the token match a pairing of the application and the node in the runtime inventory, enabling communication between the application and the node.

In a further embodiment, the operations can further comprise, in response to determining that the application and node paired in the token do not match a pairing of the application and the node in the runtime inventory, denying communication between the application and the node.

In further embodiments, a computer-implemented method is provided, wherein the method comprises receiving, by a device comprising at least one processer, an application (xApp) configured for an onboarding at network equipment of a radio access network (RAN), wherein the xApp comprises a security descriptor, further modifying, by the device, the security descriptor in accordance with a defined schema implemented at the network equipment of the RAN, the modifying resulting in a modified security descriptor; and further, onboarding, by the device, the xApp with the modified security descriptor.

In an embodiment, the xApp can be a containerized xApp configured to be deployed on a container orchestration layer (COL) located within the network equipment of the RAN. In another embodiment, the security descriptor can comprise an xApp container parameter.

In a further embodiment, the computer-implemented method can further comprise, signing, by the device, the xApp with a signature, wherein the signature indicates the xApp has been modified with the defined schema.

In a further embodiment, the computer-implemented method can further comprise receiving, by the device, the xApp for deployment at the COL, further determining, by the device, the xApp comprises the signature indicating the xApp has been modified with the defined schema, and further, deploying, by the device, the xApp at a worker node of the COL, wherein the worker node can be configured in accordance with the xApp container parameter.

Further embodiments can include a computer program product stored on a non-transitory computer-readable medium and comprising machine-executable instructions, wherein in response to being executed, the machine-executable instructions cause a first system that is part of a radio access network (RAN) to perform operations, comprising receiving a first xApp to be onboarded at a second system of the RAN, the first xApp comprises a binary parameter configurable with a first setting and a second setting, further applying a schema to the first xApp, wherein the schema comprises the binary parameter configured with the first setting, and further configuring the binary parameter with the first setting.

In an embodiment, the first xApp can be received with an initial scope of implementation on an O-cloud platform, wherein the first setting limits scope of implementation of the first xApp on the O-cloud platform to the initial scope of implementation, and further, the second setting configures the first xApp with unlimited scope of implementation of the xApp on the O-cloud platform.

In another embodiment, the operations can further comprise creating an xApp container on a container orchestration layer (COL), wherein the xApp container is configured in accordance with the binary parameter configured with the first setting.

In another embodiment, the operations can further comprise signing the first xApp to indicate that the first xApp has been configured with the binary parameter and the first setting, further detecting a container creation event at a container orchestration layer, wherein the container creation event is initiated by a second xApp, further analyzing the second xApp for a signature indicating that the second xApp has been configured with the binary parameter and the first setting, and further, in response to determining the second xApp does not comprise the signature, preventing the second xApp from being onboarded.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates a system to securely implement one or more xApps on a RAN, in accordance with one or more embodiments.

FIG. 2 presents example codes/schema to provide context regarding operation of a conventional, insecure RAN.

FIG. 3 illustrates an xApp descriptor schema being configured in accordance with a defined schema, in accordance with an embodiment.

FIG. 4 illustrates an xApp deployer component and a schedule component being utilized to deploy (e.g., post onboarding) an xApp(s) to the RAN, in accordance with an embodiment.

FIG. 5 illustrates controlling secure communication between an xApp and a node on a RAN, in accordance with an embodiment.

FIG. 6 presents a computer-implemented method for securely onboarding, deploying, and implementing an xApp on a RAN, in accordance with an embodiment.

FIG. 7 presents a computer-implemented method for securely onboarding an xApp on a RAN, in accordance with an embodiment.

FIG. 8 presents a computer-implemented method for securely deploying an xApp on a RAN, in accordance with an embodiment.

FIG. 9 presents a computer-implemented method for securely deploying an xApp on a RAN, in accordance with an embodiment.

FIG. 10 presents a computer-implemented method for initiating secure xApp-E2Node communications for an xApp deployed on a RAN, in accordance with an embodiment.

FIG. 11 illustrates a block flow diagram for a system associated with onboarding, deploying, and/or subscribing xApps on a RAN, in accordance with one or more embodiments presented herein.

FIG. 12 illustrates a block flow diagram for a process associated with securely implementing xApps on a RAN, in accordance with one or more embodiments presented herein.

FIG. 13 illustrates a block flow diagram for a process associated with onboarding, deploying, and/or subscribing xApps on a RAN, in accordance with one or more embodiments presented herein.

FIG. 14 illustrates an example wireless communication system, in accordance with one or more embodiments described herein.

FIG. 15 presents an example environment for implementing various embodiments presented herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### Terms

xApp: an application deployable at an O-RAN (e.g., at a RAN Intelligent Controller (RIC)) and configured to optimize/automate RAN operations/workloads in conjunction with supporting use cases directed at lowering an operator's (e.g., a mobile operator) total cost of ownership (TCO), enhancing a customer's quality of experience (QoE), and suchlike. xApps are applications implemented regarding workloads requiring near-real time (near-RT) processing/implementation (e.g., a first range of time, such as less than 1 second, between 10 milliseconds and 1 second, etc.). xApps enable near-RT optimization and control and data monitoring of CU and DU nodes. xApps can be deployed as containerized applications, whereby a container packages an application, and during deployment on a container orchestration layer, registry information in the xApp can be utilized to configure the launching the container.

xApp Descriptor: an xApp descriptor includes information for the RIC platform to manage the life cycle of the xApp. Information and configurations included in the xApp descriptor can be used to define flow of data in both northbound and southbound traffic. xApp developer can also include self-defined internal parameters that will be consumed by the xApp in the xApp descriptor. An xApp descriptor can be provided by the xApp writer. An xApp descriptor can be generated using JSON structure, and can comprise of the following sections:
an xapp_name (a unique identifier to address the xApp),
version (semantic version of an xApp descriptor),
containers (defines a list of containers that the xApp will run. For each container, the following are/can be defined, container name, image registry, image name, image tag, and command that it runs),
controls (internal configuration of an xApp),
metrics (metrics provided by an xApp),
messaging (communication ports for respective containers), and suchlike.

Nodes & E2 Nodes: RAN architecture can include a range of units referred to as nodes, such as central units (CUs), distributed units (DUs), and radio units (RUs). Generally, CUs centralize RAN packet processing functions, DUs conduct baseband processing functions across cell sites, and RUs provide radio functions at antenna sites (e.g., conversion, transmission, and/or receipt, of radio signals from digital signals). While the RUs are located at antenna sites, the locations of CUs and DUs are not fixed to any particular geographic area or site. DUs can be co-located with RUs local to an antenna, also DUs can be located many miles from RUs, whereby connection between the DUs and RUs is by any suitable technology, e.g., fiber optics. CUs and DUs can be located “in the cloud”, such as at a data center which may or may not be proximal to the RU.

O-cloud: an operational/architectural layer including hardware and software components providing cloud computing capabilities to execute various RAN functions. O-cloud functions/architecture can include O-DU, O-CU-CP, O-CU-UP, O-eNB, near-RT RIC, non-RT RIC, nodes (e.g., E2 nodes), and suchlike. An entity utilizing the O-Cloud can implement modeling regarding how resources are deployed/utilized in the O-Cloud, whereby resources can include, for example, a compute resource, a storage resource, a networking resource, a cloud resource, and suchlike. In an aspect, an O2 interface can be utilized to interface/access the O-Cloud from an upper-level management domain/layer (e.g., the SMO).

RAN Intelligent Controller (RIC): The RIC is an O-RAN component configured to control and optimize RAN functions. The RIC enables O-RAN disaggregation with regard to onboarding of multi-vendor/third-party xApps to automate/optimize RAN operations, e.g., with regard to use cases that lower mobile operators' TCO, enhance customers' QoE, and suchlike. The RIC can control what xApps are deployed on a RAN. For some context, example, non-limiting Non-Real Time RIC (Non-RT RIC) functions include service and policy management, RAN analytics, and model training for the near-Real Time RICs. In this regard, the Non-RT-RIC enables non-real-time (e.g., a first range of time, such as >1 s) control of RAN elements and their resources through applications, e.g., specialized applications called xApps. Example, non-limiting Near-Real Time RIC (near-RT RIC) functions enable near-real-time optimization and control and data monitoring of CU and DU nodes in near-RT timescales (e.g., a second range of time representing less time than the first time range, such as between 10 ms and 1 s).

Service management orchestration (SMO) framework: can be configured to function as the management and orchestration layer controlling configuration and automation aspects of RIC and RAN elements.

n is any positive integer.

### 1. Overview

xApps may be 3^{rd} party applications deployed within a RAN intelligent controller (RIC), whereby the RIC (and an xApp implemented thereon) accesses and controls respective elements of a RAN and/or performance of a node (e.g., an E2 Node) incorporated into the RAN. xApps are deployed in the form of containers, e.g., on a container orchestration layer, with such implementation exposing the xApp/xApp container to various security vulnerabilities. While an impetus of O-RAN is for an open, disaggregated RAN, the openness of the RAN architecture and protocols can give rise to an attack by a malicious entity. For example, an attacker can attempt to implement (e.g., manually) a malicious xApp on the RAN, e.g., at the container orchestration layer, resulting in degradation of performance of operations performed at the RIC and/or the RAN. Owing to the level of access available to an xApp, via the RIC, a high level of security/defense in depth layers should be implemented to mitigate an entity utilizing a malicious xApp to attack/degrade operational performance of the RAN.

The various embodiments presented herein relate to configuration and implementation of xApps securely across a RAN throughout a respective lifecycle of a respective xApp. As further described herein, during the respective phases/portions of the xApp(s) lifecycle, various xApp security measures are implemented, wherein the measures can be implemented prior to onboarding through to O-Cloud deployment (aka E2 integration). Respective portions of an xApp lifecycle, and security measures implemented, include:
i) onboarding of the xApp—during this phase, a secure configuration is implemented at an xApp(s) to ensure the xApp functions in a secure manner, and to further enable an onboarding process to proceed. The secure configuration can be implemented by a hardener component located at the RIC, wherein the hardener component can be configured to add/modify one or more parameters/settings included in a security defined descriptor of the xApp. In an embodiment, rather than a conventional approach of validating the one or more parameters, the hardener component can configure/adjust one or more parameters in accordance with defined parameters/settings (e.g., as defined in a security schema by a security administrator overseeing operation of the RAN).
ii) deployment (post onboarding) of the xApp—during this phase an xApp manager/schedule component, located in the RIC, can be configured to control/influence deployment of the xApp on a container orchestration layer (COL). xApp container scheduling in the COL can be delegated to the xApp schedule component, hence ensuring xApp containers deployed within a cluster at the COL are only deployed through the xApp schedule component, rather than manually deployed within the cluster/directly to COL/control plane.
iii) node communication/deployment communication (post onboarding/subscription)—during this phase, an AppManager component can be configured to ensure correct/proper xApp-node communications (e.g., at an E2 node). During initiation of communication between xApps and E2 nodes, validation is performed at the E2 node-end based on xApp/container runtime parameters available through a runtime security function associated with the SMO, wherein the E2 node and the SMO have previously established trust.

### 2. System Overview

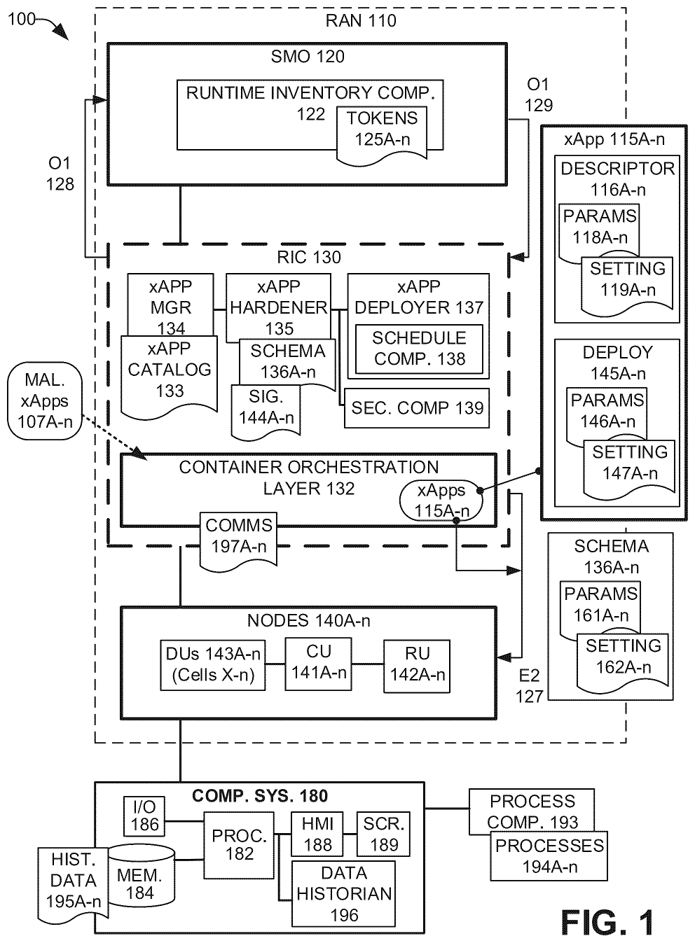

FIG. 1, schematic 100, illustrates a system to securely implement one or more xApps on a RAN, in accordance with one or more embodiments.

FIG. 1 presents a RAN 110 for which respective xApps 115A-n can be configured to be deployed on. RAN 110 includes an SMO layer/component 120 communicatively coupled to a RIC 130, whereby the RIC 130 can include a container orchestration layer (COL) 132. COL 132 is a layer for production grade container deployments (e.g., deployment of containerized xApps 115A-n). A container-based RAN 110 requires a secure carrier/production grade COL 132. Communication between SMO 120 and RIC 130 can be via respective O1 interfaces 128 and 129.

The RIC 130 is further communicatively coupled to various nodes 140 (e.g., E2 nodes), for example one or more of a CU 141A-n, RU 142A-n, and/or DU 143A-n. xApps 115A-n can be used to control operation of respective components/devices/systems distributed across the infrastructure of RAN 110, for example, CU 141A-n, and/or DU 143A-n, via an E2 interface 127 (e.g., “southbound” from the RIC 130 to nodes 140A-n, utilizing an E2 interface protocol).

The SMO 120 can be configured to control configuration and automation aspects of respective components/elements of RAN 110, RIC 130, and nodes 140A-n. The SMO 120 can be further configured to coordinate deployment of respective xApps 115A-n, which, in an example scenario, can involve the SMO 120 operating in conjunction with the RIC 130 to implement xApps 115A-n at the one or more nodes 140A-n, via deployment of the xApps 115A-n on the COL 132.

As further shown, a runtime inventory component 122 is located in SMO 120. As further described, the runtime inventory component 122 can be configured to monitor/track implementation of xApps 115A-n and the nodes 140A-n on which the xApps 115A-n are deployed. The runtime inventory component 122 can further implement tokens 125A-n (aka communication tokens) facilitating onboarding/deployment of xApps 115A-n at a node(s) 140A-n, as further described.

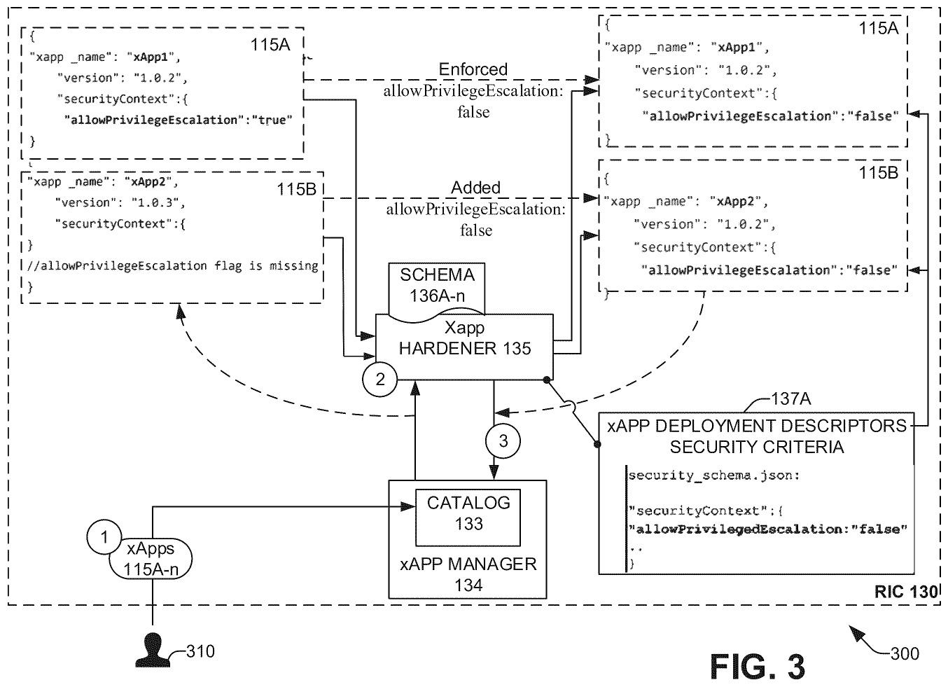

In an embodiment, xApps 115A-n can be containerized applications deployable across RAN 110. As further described, xApps 115A-n can include a descriptor schema 116A-n, wherein the descriptor schema 116A-n can be utilized during onboarding of xApp 115A-n. In an embodiment, a respective descriptor 116A-n can further include various parameters 118A-n having configurable settings 119A-n, regarding deployment of the xApp 115A-n on COL 132 and node 140A-n. As further described, per FIG. 3, descriptors 116A-n and associated parameters 118A-n/settings 119A-n can be utilized to securely onboard an xApp 115A-n.

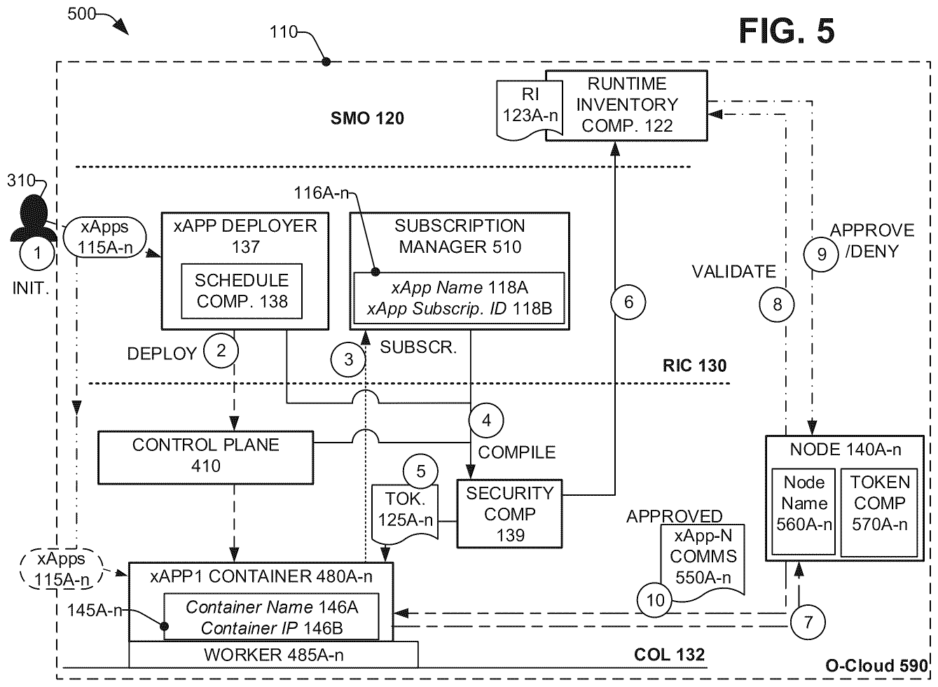

In a further embodiment, xApps 115A-n can further include a container deployment configuration 145A-n (e.g., xApp container deployment schema) including deployment parameters 146A-n/settings 147A-n. Deployment parameters 146A-n can include xApp image registry hostname and port, xApp image tag, xApp package signature (e.g., signature 144A-n, as signed by a xApp hardener component 135, as further described). As further described, per FIG. 5, deployment configuration 145A-n including deployment parameters 146A-n/settings 147A-n, can be utilized to securely deploy an xApp 115A-n as an xApp container (e.g., xApp container 480A-n), and further enable xApp-node communications (e.g., communications 550A-n, aka xApp-E2node communications).

As shown in FIG. 1, the RIC 130/COL 132 can include an xApp manager component 134 configured to monitor/control deployment of xApps 115A-n on the RAN 110. xApp manager component 134 can further compile/maintain a catalog 133 with the respective xApp descriptors 116A-n (e.g., after enforced updating) and container configurations 145A-n, to enable subsequent tracking/verification that an xApp 115A-n has been reviewed/configured by an xApp hardener component 135 (hereinafter referred to as hardener 135) further included in RIC 130/COL 132. As further described, hardener 135 can be configured to implement/adjust the one or more security parameters 118A-n of xApp descriptor 116A-n (e.g., prior to onboarding of the xApp 115A-n) in accordance with a defined security schema 136A-n (e.g., an xApp security descriptor schema), whereby schema 136A-n can be defined/configured by an RAN administrator (e.g., a security administrator, not shown). Schema 136A-n can include parameters 161A-n comparable to parameters 118A-n and/or parameters 146A-n, and settings 162A-n comparable to settings 119A-n and/or settings 147A-n, such that, as part of enforcing schema 136A-n, hardener 135 can identify comparable parameters 161A-n versus 118A-n/146A-n and enforce/replace settings 162A-n on settings 119A-n/147A-n. Upon enforcing an xApp descriptor 116A-n, the hardener component can further sign the xApp 115A-n package with a signature 144A-n.

RIC 130/COL 132 can further include a security function component 139 configured to generate tokens 125A-n for communications between an xApp 115A-n and nodes 140A-n. Tokens 125A-n can be generated/utilized based on the enforced descriptor schema 116A-n and parameters 118A-n (having settings 119A-n) and xApp runtime/deployment schema 145A-n and parameters 146A-n (having settings 147A-n) and, and further based on, interaction between the runtime inventory component 122 and a node 140A-n which the xApp 115A-n is attempting to communicate with (e.g., per FIG. 5, token component 570A-n).

In a further embodiment, an xApp deployer component 137 can be included in RIC 130, whereby xApp deployer component 137 can further include a schedule component 138 (aka a container orchestration scheduler, a container orchestration module), whereby the schedule component 138 can be further configured to control deployment of xApps 115A-n (and xApps 107A-n) on the COL 132.

The respective components in RAN 110 can authenticate with each other using any suitable authentication technique/technology, e.g., public key infrastructure (PKI), Mutual transport layer security (mTLS), and suchlike. For example, SMO 120 can authenticate with all components in RIC 130 and nodes 140A-n when communication therebetween is required, e.g., using mTLS.

Various communications 197A-n can be utilized across the RAN 110, between SMO 120 (and included components), RIC 130 (and included components), COL 132 (and included components), nodes 140A-n (and included components), xApps 115A-n, xApp containers 480A-n (as further described), and computer system 180. Communications 197A-n can include notifications, instructions, selections, data, information (e.g., descriptor 116A-n/parameters 118A-n/settings 119A-n, deployment configuration 145A-n/parameters 146A-n/settings 147A-n), tokens 125A-n, signature 144A-n, and suchlike.

As shown in FIG. 1, any of the components (e.g., SMO 120 and subcomponents, RIC 130 and subcomponents, COL 132 and subcomponents, nodes 140A-n and subcomponents) located in RAN 110 can be communicatively coupled to a computer system 180. The computer system 180 can comprise a processor 182 and a memory 184, wherein the processor 182 can execute the various computer-executable components, functions, operations, etc., presented herein, e.g., any of components in SMO 120, runtime inventory component 122, components in RIC 130, xApp manager 134, xApp hardener 135, xApp deployer 137, schedule component 138, security component 139, components in COL 132, container event tracker 420, control plane 410, token component 570A-n, components in nodes 140A-n, CUs 141A-n, RUs 142A-n, DUs 143A-n, and suchlike. The memory 184 can be utilized to store the various computer-executable components, functions, code, etc., as well as information regarding any of xApps 115A-n, xApps 107A-n, descriptor 116A-n/parameters 118A-n/settings 119A-n, container deployment schema 145A-n/parameters 146A-n/settings 147A-n, schema 136A-n, container parameters (e.g., name 146A, identifier 146B), tokens 125A-n, communications 550A-n, subscription parameters (e.g., name 118A, identifier 118B), node name 560A-n, signatures 144A-n, vectors V₁₋ₙ, similarity indexes S₁₋ₙ, processes 194A-n, historical data 195A-n, and suchlike.

As further shown, computer system 180 can include an input/output (I/O) component 186, wherein the I/O component 186 can be a transceiver configured to enable transmission/receipt of information and data between any of the components included in RAN 110. I/O component 186 can be communicatively coupled to the remotely located devices and systems. In an embodiment, I/O component 186 can be configured to transmit various communications 197A-n, 550A-n regarding xApps 115A-n.

In an embodiment, the computer system 180 can further include a human-machine interface (HMI) 188 (e.g., a display, a graphical-user interface (GUI)) which can be configured to present various information including any of xApps 115A-n, xApps 107A-n, descriptor 116A-n/parameters 118A-n/settings 119A-n, deployment schema 145A-n/parameters 146A-n/settings 147A-n, schema 136A-n, container parameters (e.g., name 146A, identifier 146B), tokens 125A-n, communications 550A-n, subscription parameters (e.g., name 118A, identifier 146B), etc., per the various embodiments presented herein. The HMI 188 can include an interactive display 189 to present the various information via various screens presented thereon, and further configured to facilitate input of information/settings/etc., regarding the xApps 115A-n, xApps 107A-n, etc.

RAN 110 can further include a data historian 196 configured to compile historical data 195A-n (e.g., prior and/or current data/information/knowledge) regarding operation of RAN 110 and respective components included therein, e.g., SMO 120, RIC 130, COL 132, nodes 140A-n, malicious xApps 107A-n, xApps 115A-n, xApp containers 480A-n, events 425A-n, tokens 125A-n, xApp-node communications 550A-n, schema 136A-n, descriptors 116A-n, deployment configurations 145A-n, and suchlike with regard to securely onboarding, deploying, and subscribing xApps 115A-n/107A-n on RAN 110.

RAN 110 can further include a process component 193 and processes 194A-n. In an embodiment, processes 194A-n can be utilized monitor/recommend actions regarding onboarding/deployment/subscription of xApps 115A-n and xApp containers 480A-n on the RAN 110, as further described.

It is to be appreciated that while process component 193, processes 194A-n, data historian 196, and historical data 195A-n are depicted as being included/coupled to computer system 180, process component 193, processes 194A-n, data historian 196, and historical data 195A-n and be located and implemented at any suitable location/activity/process undertaken across RAN 110, SMO 120, RIC 130, COL 132, nodes 140A-n, etc.

### 3. Conventional Approach

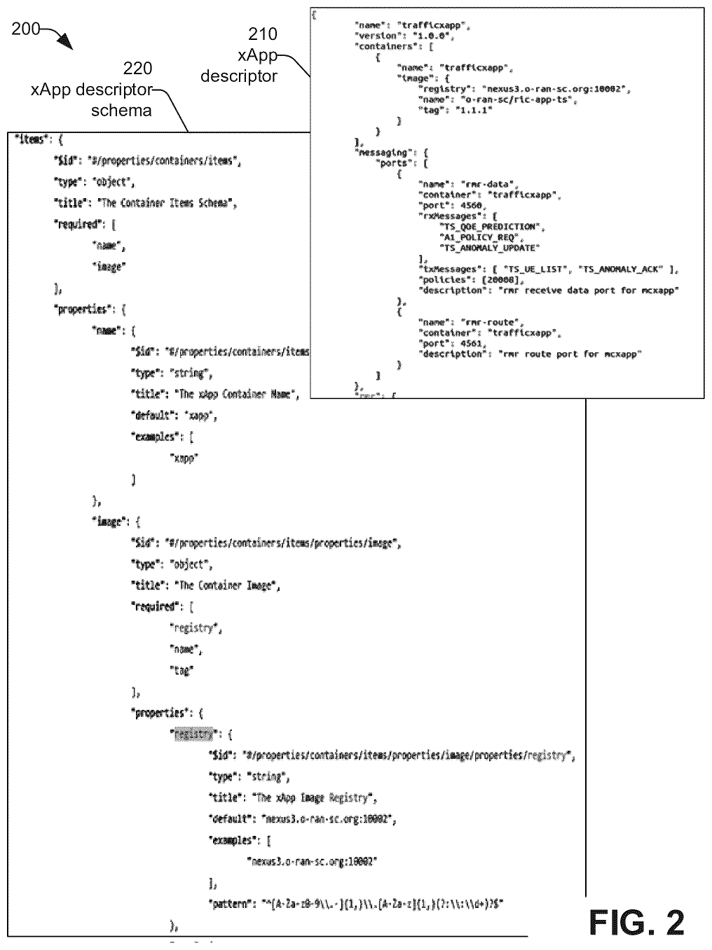

Turning briefly to FIG. 2, example codes 210 and 220 are presented to provide context regarding operation of a conventional, insecure RAN.

Code 210 presents an example of an xApp descriptor file (e.g., comparable to descriptor 116A-n), whereby the xApp descriptor file can be included inside the container section information (e.g., in container deployment information 145A-n) of an xApp. Various parameters (e.g., comparable to parameters 118A-n) can be defined, including:
Registry
Image Name
Image Tag

Code 220 is a snippet of an xApp descriptor schema (e.g., schema 136A-n). During onboarding of an xApp with a conventional onboarding process, parameters/settings in an xApp descriptor file (e.g., code 210) are compared with the schema code 220. In the event of respective portions of code 210 do not match the required values of schema code 220, the xApp onboarding process fails. The conventional process only validates the respective parameters/settings in the xApp to the schema code 220, and unlike the one or more embodiments presented herein (e.g., via use of the hardener component 135), the parameters in a conventional onboarding xApp process are not secured against the default/secure settings defined in schema code 220. Further, with a conventional process, the xApp container orchestration layer (e.g., COL 132), and components utilized thereon, are unaware of the verification process being performed and/or the outcome of the verification process. Hence, with a conventional approach, if a malicious entity (e.g., entity 411) schedules onboarding of a malicious xApp 107A-n at the container orchestration layer, it is possible for the entity to deploy a malicious xApp 107A-n on RAN 110.

### 4. Secure Onboarding of an xApp

FIG. 3, schematic 300, illustrates an xApp descriptor schema being configured in accordance with a defined schema, in accordance with one or more embodiments. As shown, respective xApps 115A-n are being submitted for onboarding on the RAN 110.

Reviewing FIG. 3, steps 1-3 are presented regarding implementation of hardener 135.

At 3:1, onboarding of xApp 115A-n can be initialized by an entity 310 intending to deploy xApp 115A-n onto the RAN 110 (e.g., at nodes 140A-n). In an embodiment, xApp 115A-n can be received as a packaged and signed compressed file.

At 3:2, xApp hardener 135 can be configured to parse parameters 118A-n/settings 119A-n in the descriptor 116A-n, and modify the parameters according to the descriptor schema 136A-n, enabling security by default design for all onboarded xApps 115A-n. xApp hardener 135 can be configured to decompress the xApp 115A-n and extract respective xApp descriptors 116A-n included in the xApp 115A-n. As previously mentioned, during onboarding, xApp hardener 135 can be utilized to analyze the respective xApp descriptors 116A-n regarding the included parameters 118A-n and settings 119A-n, and further compare the descriptors 116A-n with the defined schema 136A-n. In the event of one or more settings 119A-n of parameters 118A-n in the xApp descriptor 116A-n do not match the defined schema 136A-n, hardener 135 can be further configured, by default, to enforce/implement the defined schema 136A-n on the parameters 118A-n/settings 119A-n. While the hardener 135 is described in the forgoing as enforcing schema 136A-n on parameters 118A-n/settings 119A-n, the hardener 135 can utilize a schema 136A-n to enforce/implement any suitable features, e.g., modification of a manifest associated with xApp 115A-n.

An example security schema is presented in TABLE 1, below:

TABLE 1
Example of allowPrivilegeEscalation parameter 118A-n being
enforced in accordance with a security schema 136A-n.

| | | ENFORCED/ NEW |
|---|---|---|
| | | PARAMETER PER |
| SECURITY | EXISTENT/INITIAL FORM | SCHEMA 136A-n & |
| PARAMETER | PARAMS 118A-n/146A-n | PARAM/SETTING |
| (PARAM 161A-n) | SETTINGS 119A-n/147A-n | 161A-n/162A-n. |
| allowPrivilegeEscalation | No | allowPrivilegeEscalation: false |
| | allowPrivilegeEscalation: true | allowPrivilegeEscalation: false |

To aid further understanding, two xApps 115A-n are presented for example illustration of the various embodiments. In the examples, the allowPrivilegeEscalation parameter 118A is being enforced. During programming/implementation, the allowPrivilegeEscalation has a binary setting 119A, such that when set to true, allows an xApp 115A-n to potentially generate a container process that has unlimited ability to gain more privileges/privilege escalation, e.g., than the initially implemented xApp. Privilege escalation can be of use to an entity deploying a malicious xApp 107A onto a RAN 110. Hence, in an aspect, one approach to ensuring a container has limited scope is to set/ensure allowPrivilegeEscalation: false.

Per the foregoing, in an example scenario, a first xApp 115A (shown in FIG. 3 as xApp1), includes a parameter 118A allowPrivilegeEscalation having a setting 119A of true. However, to ensure security of RAN 110, schema 136A defines/requires the allowPrivilegeEscalation parameter 161A-n to have a setting 162A-n offalse. Accordingly, hardener 135 changes the initial setting of allowPrivilegeEscalation=true with a setting allowPrivilegeEscalation=false, such that parameter 118A is now configured with a setting 119B of false (e.g., per TABLE 1).

In another example scenario, a second xApp 115B, shown in FIG. 3 as xApp2, is missing the allowPrivilegeEscalation parameter 118A, while, as previously mentioned, the schema 136A requires allowPrivilegeEscalation=false. Accordingly, hardener 135 can amend/insert the parameter 118A/setting 119A allowPrivilegeEscalation=false into the xApp descriptor 116A-n (e.g., using parameter 161A-n and setting 162A-n).

Hence, per the example configurations enforced by hardener 135, both the first xApp 115A and the second xApp 115B include the parameter 118A/setting 119A of allowPrivilegeEscalation=false in the xApp descriptor 116A-n, in accordance with schema 136A.

At 3:3, per the foregoing, xApps 115A-n are onboarded onto RAN 110, with the hardener 135 further configured to sign the amended xApps 115A-n with the new security parameters 118A-n/settings 119A-n. The amended/signed xApp 115A-n can be added to xApp catalog 133 by xApp manager 134 for use in subsequent deployment of xApp 115A-n.

It is to be appreciated that any parameter can be utilized to control secure implementation of an xApp 115A-n, hence, while the various example scenarios relate to the allowPrivilegeEscalation parameter, any suitable parameter can be utilized with the various embodiments presented herein.

### 5. Secure Deployment of an xApp

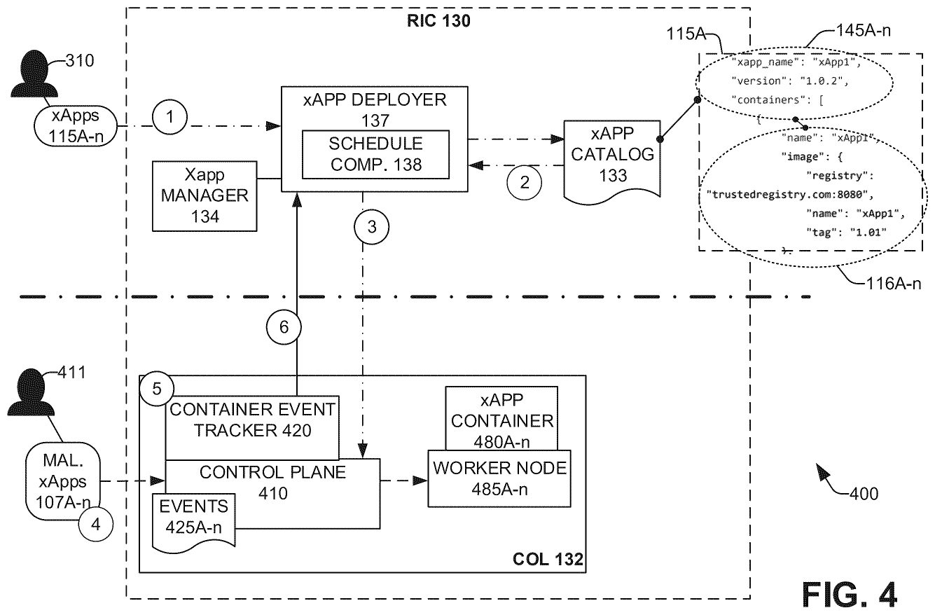

FIG. 4, schematic 400, illustrates an xApp deployer component and a schedule component being utilized to deploy (e.g., post onboarding) an xApp(s) to the RAN, in accordance with an embodiment.

As previously mentioned, an xApp deployer component 137 and a schedule component 138 can be incorporated into the RIC 130. As further described, the xApp deployer component 137/schedule component 138 provide an additional pipeline for deploying xApps 115A-n onto the COL 132. In an embodiment, by deploying xApps 115A-n via the xApp deployer component 137/schedule component 138, another layer of xApp security is provided as it is possible to segregate, via deployer component 137/schedule component 138, secure xApps 115A from potentially malicious xApps 107A-n. Deployer component 137 and/or schedule component 138 can be included in xApp manager 134, or communicatively coupled thereto.

As further shown, COL 132 further includes a control plane 410 on which the respective xApps 115A-n are deployed, whereby information in either of the descriptor 116A-n and/or the deployment schema 145A-n defines/indicates which nodes 140A-n an xApp 115A-n is to be deployed on, via the control plane 410/COL 132. During deployment of an xApp 115A-n at the COL 132, xApp-container related parameters (e.g., in the deployment schema 145A-n) such as images, registries, tags, and suchlike, are to be exclusively deployed at the COL132. As shown, the control plane 410 can be coupled to a container event tracker component 420, whereby the tracker component 420 can be configured to detect/capture any container creation events 425A-n generated by an xApp being deployed on the control plane 410. Hence, with benign xApps 115A-n being deployed via xApp deployer 137 and malicious xApps 107A-n attempted to be deployed, e.g., by attacker 411, at the control plane 410 and captured by the container tracking event component 420, two distinct paths are utilized and controlled.

Rather than deploying a benign xApp 115A-n directly to the control plane 410, as per a conventional, insecure approach, the benign xApp 115A-n is received at the xApp deployer 137 at the RIC 130, content of the xApp 115A-n is confirmed/identified, and then the benign xApp 115A-n is deployed to the control plane 410. Accordingly, rather than with a conventional approach of deployment operations being performed at the control plane 410, the deployment operations (e.g., per deployment schema 145A-n) are delegated to the xApp deployer 137/schedule component 138. In a further embodiment, the xApp deployer 137/schedule component 138 can operate in conjunction with a container event tracker 420, and monitor deployment operations occurring at COL 132/control plane 410, and accordingly, the xApp deployer 137/schedule component 138 is aware of expected and unexpected deployment operations occurring at COL 132/control plane 410.

Per the foregoing, the respective steps 4:1-4:6 present two scenarios of deploying xApps on a control plane 410. In a first scenario, steps 4:1-4:3, an xApp 115A-n is being deployed in accordance with the various embodiments presented herein, whereby a pre-configured xApp 115A-n is received (per FIG. 3) and applied to the control plane 410 via the xApp deployer 137 and schedule component 138. The first scenario provides a secure deployment of a secure/benign xApp 115A-n on the control plane 410/nodes 140A-n. In a second scenario, steps 4:4-4:6, a potentially malicious xApp 107A-n is attempted to be deployed directly to the control plane 410/nodes 140A-n, but is captured (e.g., by container event tracker 420) prior to xApp 107A-n being deployed on a node 140A-n. The second scenario enables a malicious xApp 107A-n to be captured and identified prior to implementation on the nodes 140A-n.

At 4:1, an entity 310 initiates deployment of xApp 115A-n at the RIC 130/COL 132. In an aspect, when an xApp 115A-n is onboarded, xApp container specific deployment information 145A-n, e.g., parameters 146A-n/settings 147A-n and parameters 118A-n/settings 119A-n can be captured/stored in catalog 133 (e.g., in memory 184) at xApp manager 134 in the RIC 130.

At 4:2, the schedule component 138 can be configured to validate/confirm xApp deployable container parameters 146A-n/settings 147A-n against an xApp catalog 133 during deployment of xApps 115A-n, to confirm the respective xApps 115A-n have correct parameters 146A-n/settings 147A-n. In an embodiment, owing to an xApp 115A having been previously operated on, e.g., via the hardener 136, xApp 115A is known to the xApp deployer 137 and xApp 115A should be present in catalog 133.

At 4:3, in an embodiment, owing to xApp container specific deployment information 145A-n, e.g., parameters 146A-n/settings 147A-n includes the descriptor 116A-n and previously defined/enforced parameters 118A-n/settings 119A-n (e.g., per FIG. 3), xApp schedule component 138 can deploy xApp 115A to the control plane 410, e.g., as an xApp container 480A-n deployed on a worker node 485A-n, wherein the worker node 485A-n is configured to execute the deployed xApp container 480A-n.

At 4:4, in another example of operation, an attacker 411 attempts to deploy (e.g., manually) a potentially malicious xApp 107A at the control plane component 410 of COL 132. As shown, the control plane 410 can be coupled to a container event tracker 420, whereby the container event tracker 420 can be configured to detect/capture any container creation events 425A-n generated by an xApp. As mentioned, container event tracker 420 can operate in conjunction with xApp deployer 137/schedule component 138. Hence, in the event of a malicious xApp 107A is attempted to be deployed, deployment information regarding the deployment of malicious xApp 107A can be captured (e.g., by the container event tracker 420) and compared with information in the xApp catalog 133, as further described.

At 4:5, as part of onboarding malicious xApp 107A directly onto the control plane 410, any container creation events 425A-n initialized at the control plane 410 by xApp 107A can be captured by the container event tracker 420 and further forwarded the container creation events 425A-n to the schedule component 138.

At 4:6, in the event of container creation events 425A-n includes one or more parameters/settings that do not match the safe/secure settings defined in either of schema 136A-n and/or catalog 133, and further, the xApp 107A is not present in the catalog 133, the schedule component 138 can be configured to prevent/deny deployment of malicious xApp 107A on the control plane 410 and at node(s) 140A-n.

### 6. Secure Communication Subscription of xApp with Node/E2 Integration

FIG. 5, schematic 500, illustrates controlling secure communication between an xApp and a node on a RAN, in accordance with an embodiment.

At 5:1, entity 310 initializes deployment of xApp 115A (e.g., xApp1, a benign xApp) to a COL 132/control plane 410. COL 132, and also SMO 120, RIC 130, and nodes 140A-n can be included in an O-cloud 590, an infrastructure configured to coordinate functions for the RAN 110, SMO 120, RIC 130, and COL 132. With reference to FIG. 4, xApp 115A-n can be deployed as an xApp container 480A-n deployed on the worker node 485A-n.

At 5:2, as previously described per FIG. 4, xApp 115A-n is deployed to the COL 132/control plane 410 via the xApp deployer 137 and schedule xApp 115A.

At 5:3, xApp 115A is subscribed at the RIC 130, whereby subscription is via a subscription manager component 510. Subscriptions parameters such as xApp name 118A and xApp subscription identifier 118B pertaining to xApp 115A can be stored at the subscription manager component 510 (e.g., in memory 184).

At 5:4, after deployment of xApp 115A-n on COL 132, a security component 139 (e.g., a secure function) deployed within COL 132 can be configured to communicate with the subscription manager component 510. During the communication, security component 139 can be configured to gather information regarding xApp 115A-n, such as container runtime information, e.g., container name 146A/container IP address 146B from xApp deployer 137/schedule component 138/control plane 410. Further, any runtime security function xApp parameters can be obtained/gathered from the xApp subscription manager component 510, such as xApp1 name 118A and xApp1 subscription identifier 118B pertaining to xApp 115A.

At 5:5 & 5:6, the security component 139 can be further configured to generate a token 125A-n (e.g., a security token, a secure function generated token), whereby token 125A-n can be generated based on various container runtime/xApp parameters (e.g., container name 146A/container IP address 146B, xApp1 name 118A/xApp1 subscription identifier 118B), as previously mentioned, and further listed below. Further, security component 139 can generate token 125A-n based on any suitable security technique/technology, for example, token 125A-n can be generated using a secure hash algorithm (SHA) concatenation, e.g., SHA3.

Parameters utilized to generate token 125A-n can include:
a) xApp 115A-n descriptor/specific parameters 118A-n in descriptor 116A-n:
   xApp 115A-n name 118A.
   xApp 115A-n subscription ID 118B (e.g., as assigned by RIC subscription manager 510).
b) container runtime parameters 146A-n (e.g., randomly created during creation of a container) in container deployment configuration 145A-n, such as:
xApp 115A-n container name 146A.
xApp 115A-n container IP address 146B.
c) node 140A-n name 560A-n.

Token 125A-n can be stored within the memory of the xApp 115A-n to which the token 125A-n pertains. In an embodiment, token 125A-n comprises first information identifying the xApp 115A-n paired with second information identifying a node 140A-n, wherein xApp 125A-n is attempting to establish communication with the node 140A-n.

At 5:7, token 125A-n can be sent to the node 140A-n to authenticate the xApp 115A at the node 140A-n, e.g., by token component 570A. Whenever xApp 115A-n initiates connection with a node 140A-n (aka a subscription event), xApp 115A-n can provide token 125A-n to the node 140A-n. In an embodiment, the copy of the token 125A-1 sent to the runtime inventory component 122 can be considered to be a first token 125A-1 and the copy of the token 125A-2 stored by the xApp 115A-n and forwarded to the node 140A-n can be considered a second token 125A-2.

At 5:8, the node 140A-n can be configured to authenticate the token 125A-n with the runtime inventory component 122 and a runtime inventory 123A-n. The node 140A-n and the runtime inventory component 122 (at SMO 120) can operate in combination to validate the token 125A-n. In an embodiment, the runtime inventory 123A-n can comprise a list of all applications/xApps 115A-n approved for deployment on the network equipment of the RAN 110 (e.g., components/devices in SMO 120, RIC 130, COL 132, etc.), including node 140A-n.

At 5:9, the runtime inventory component 122 can be configured to either validate or reject the token 125A-n. In an embodiment, the runtime inventory component 122 can perform validation of token 125A-n, versus the runtime inventory 123A-n, as the runtime inventory component 122 is aware of components/devices/xApps being utilized across RAN 110, including nodes 140A-n as the SMO 120 facilitates/provisions operation of respective components on the RAN 110. The runtime inventory component 122 can be configured to create and maintain the runtime inventory 123A-n with the respective components, devices, xApps, etc. As part of an initial operation of node 140A-n, trust is established between the runtime inventory component 122 and node 140A-n, e.g., trust between the runtime inventory component 122 and node 140A-n is established prior to onboarding xApp 115A-n. In another embodiment, in the event of first token 125A-1 and second token 125A-2 are being utilized, runtime inventory component 122 can be further configured to compare content of the first token 125A-1 (e.g., a paired application 115A and node 140A) and content second token 125A-2 (e.g., a paired application 115n and node 140n), for a match, such that paired application 115A and node 140A match application 115n and node 140n.

At 5:10, in the event of runtime inventory component 122/node 140A-n validates the token 125A-n (e.g., first token 125A-1 with second token 125A-2, or first token 125A-1 with content of runtime inventory 123A-n), xApp/node communication 550A-n is established between the xApp container 480A-n at the COL 132 created from xApp 115A-n and node 140A-n. In an embodiment, the xApp-E2 node messages 550A-n are only exchanged once validation is performed between the runtime inventory component 122 and the respective node 140A-n.

At 5:10, in the event of runtime inventory component 122/140A-n is unable to validate the token 125A-n, traffic/messages 550A-n will be blocked between xApp 115A-n/xApp container 480A-n and node 140A-n, e.g., runtime inventory component 122 is unable to trust xApp 115A-n and any communication 550A-n generated by xApp 115A-n.

### 7. Methods for Onboarding, Deploying, & Subscribing an xAPP

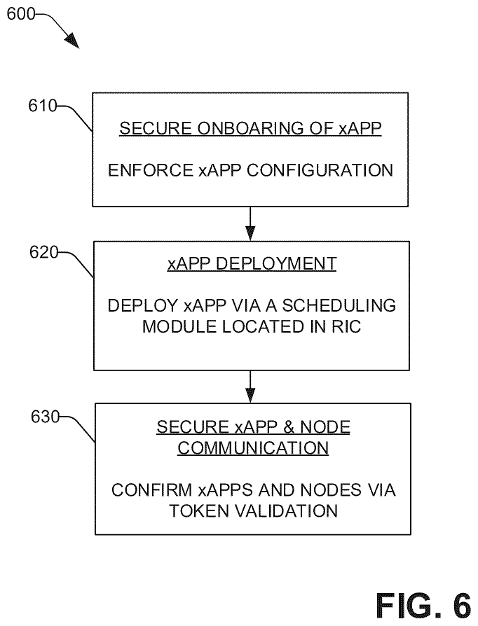

FIG. 6, via flowchart 600, presents a computer-implemented method for securely onboarding, deploying, and implementing an xApp on a RAN, in accordance with an embodiment. FIG. 6 provides an overview of the various embodiments presented herein.

At 610, an xApp (e.g., xApp 115A-n) can be presented for secure onboarding onto a RAN (e.g., RAN 110). In an embodiment, to ensure that the xApp will be implemented safely/securely on the RAN, an xApp hardener component (e.g., xApp hardener 135) can be configured to review and compare content of the xApp and with a secure schema (e.g., schema 136A-n, and parameters 161A-n and settings 162A-n). xApp content can include various parameters and settings (e.g., parameters 118A-n and settings 119A-n), which, in the event of a parameter/setting does not comply with a secure parameter/setting in the schema, the hardener component can be further configured to enforce the secure parameter/setting on the xApp. Hence, in the event of a malicious xApp (e.g., malicious xApp 107A-n) is applied to the RAN, the hardener component can be configured to amend the malicious xApp to comprise parameters that can be safely applied to the RAN.

At 620, the secure xApp can be deployed onto the RAN. Rather than a conventional approach of onboarding the xApp directly to the container orchestration layer (e.g., COL 132)/control plane (e.g., control plane 410), the xApp is initially deployed via an xApp deployer component/schedule component (e.g., xApp deployer 137 and schedule component 138) located at the RIC (e.g., RIC 130). The schedule component can be configured to compare parameters and settings of the xApp with a catalog (e.g., catalog 133), wherein the catalog includes known settings of the xApp, e.g., the settings previously enforced by the hardener component. In the event of the xApp has the required settings, the schedule component can be configured to deploy the xApp to the control plane. In the event of the xApp does not have the required settings, the schedule component can be configured to deny/prevent deployment of the xApp to the control plane.

In a further embodiment, a container event tracker (e.g., container event tracker 420) can be configured to monitor/capture events (e.g., events 425A-n) occurring at the control plane, whereby information regarding the xApp attempting to be deployed at the control plane and/or information regarding the events can be captured and forwarded to the schedule component operating at the RIC. Events at the control plane may result from a malicious xApp being deployed directly at the control plane. The captured information can be compared by the schedule component with the catalog. In the event of the xApp information/events do not match with the catalog information (e.g., the xApp is unknown to the schedule component as the xApp has not been previously reviewed, such as did not undergo parameter enforcement at the onboarding stage), the schedule component can be configured to deny/prevent deployment of the xApp to the control plane.

At 630, secure communication between an xApp/container application and a node can be implemented. A security component (e.g., security component 139) can be configured to generate a token (e.g., a token 125A-n), wherein the token can include information regarding the xApp, the container, the node (e.g., node 140A-n). The token can be provided to the xApp, and whenever the xApp/container attempts to communicate with the node, the token can be validated by a runtime inventory component (e.g., runtime inventory component 122 located in SMO 120). In the event of the token is validated, communications between the xApp/container and the node are enabled by the runtime inventory component, and in the event of the token is not validated, communications between the xApp/container and the node are denied by the runtime inventory component.

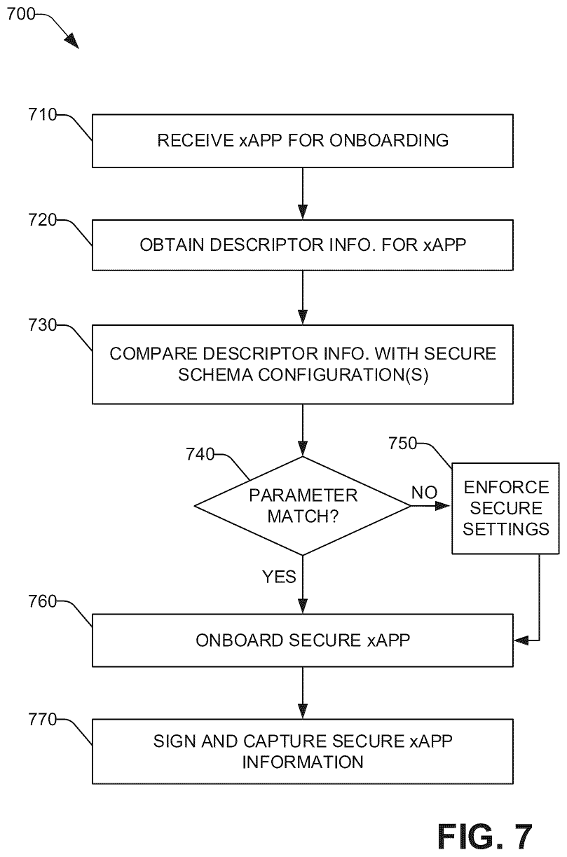

FIG. 7, via flowchart 700, presents a computer-implemented method for securely onboarding an xApp on a RAN, in accordance with an embodiment.

At 710, an xApp (e.g., xApp 115A-n) can be presented for secure onboarding to a RAN (e.g., RAN 110). The xApp can include various descriptor information (e.g., descriptor 116A-n, comprising various parameters 118A-n and settings 119A-n).

At 720, an xApp hardener component (e.g., xApp hardener 135) can be configured to obtain the descriptor information.

At 730, the hardener component can be configured to review and compare the xApp descriptor information and with a secure schema (e.g., schema 136A-n, and parameters 161A-n/settings 162A-n). In an embodiment, to ensure that the xApp will be implemented safely/securely on the RAN, an xApp content can include various parameters and settings (e.g., parameters 118A-n and settings 119A-n),

At 740, in the event of a determination by the hardener component that, NO, the parameter setting does not match the secure parameter setting (e.g., setting 162A-n) or the required parameter (e.g., parameter 161A-n) is not present, method 700 can advance to step 750, whereupon the hardener component can be further configured to enforce the secure parameter/setting on the xApp. With the xApp now comprising a secure/safe configuration, method 700 can further advance to step 760, whereupon the secure/safe xApp can be onboarded.

At 770, the hardener component can be further configured to sign (e.g., with signature 144A-n) the secure/safe xApp, and capture the current settings of the xApp, e.g., for further implementation during post-onboarding operations, as described herein. The hardener can be further configured to save the xApp, and pertinent information, to a catalog (e.g., xApp catalog 133). The catalog can comprise a set of xApps that have been reviewed by the hardener, and further, the catalog can be accessible by any component (e.g., xApp manager component 134 located in RIC 130).

At 740, in the event of the xApp has the required parameter(s)/setting(s) for the xApp to be securely deployed on the RAN 110, method 700 can advance to step 760, as previously described.

Hence, in the event of a malicious xApp (e.g., malicious xApp 107A-n) is applied to the RAN, the hardener component can be configured to amend the malicious xApp to comprise parameters that can be safely applied to the RAN. Also, knowledge of any xApp that has been reviewed by the hardener component is available for subsequent use/review, as further described.

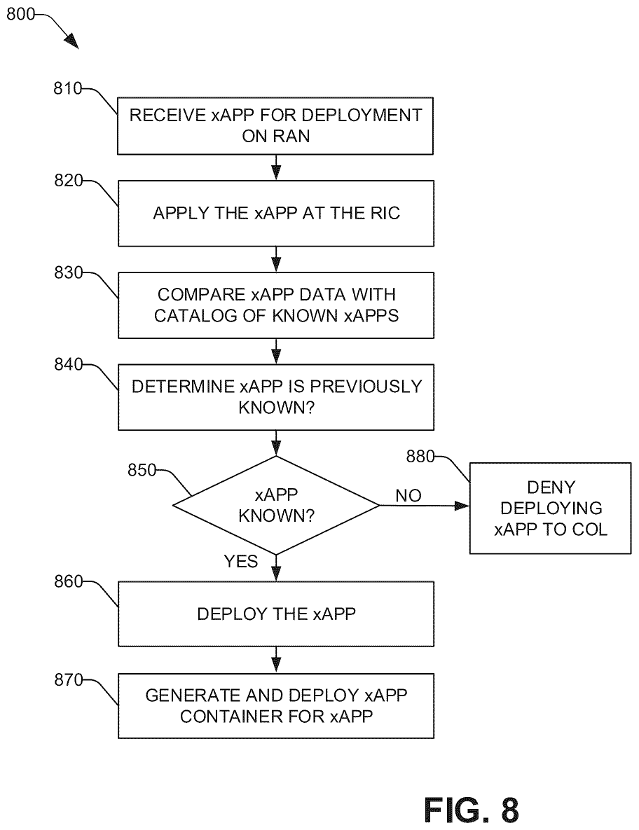

FIG. 8, via flowchart 800, presents a computer-implemented method for securely deploying an xApp on a RAN, in accordance with an embodiment.

At 810, an xApp (e.g., xApp 115A-n) can be received at a RIC (e.g., RIC 130), wherein the xApp is to be deployed onto a RAN (e.g., RAN 110). As previously described, per FIGS. 3, 6, and 7, the xApp can be previously reviewed and, if necessary, amended (e.g., by hardener 135) to have a secure configuration (e.g., of descriptor 116A-n). Accordingly, the xApp has been previously saved to a catalog (e.g., catalog 133).

At 820, an initial stage of deploying the xApp can be initially presenting the xApp to one or more components in the RIC. In an embodiment, an xApp deployer component/schedule component (e.g., xApp deployer 137 and schedule component 138) can be configured to initially receive/review the xApp. As previously mentioned, this initial stage is different to a conventional onboarding where the xApp is directly onboarded to the container orchestration layer (e.g., COL 132)/control plane (e.g., control plane 410).

At 830, the schedule component can be further configured to compare parameters and settings of the xApp with a catalog (e.g., catalog 133), wherein the catalog includes a set of known xApps and xApp settings, wherein the set of xApps and settings were previously reviewed/enforced by the hardener component.

At 840, the schedule component can be further configured to determine whether the xApp is present/conforms with one or more xApp entries in the set of xApps in the catalog.

At 850, in the event of confirmation (e.g., by the schedule component) that YES, the xApp has the required settings/is present in the set of xApps in the catalog, method 800 can advance to step 860, whereupon, the schedule component can be further configured to enable deployment of the xApp to a control plane (e.g., control plane 410) in the container orchestration layer.

At 870, as a function of deploying the xApp on the container orchestration layer, the xApp can be deployed as an xApp container (e.g., xApp container 480A-n) at a worker node (e.g., worker node 485A-n) in the container orchestration layer.

At 850, in the event of determination (e.g., by the schedule component) that NO, the xApp does not have the required settings/is not present in the set of xApps in the catalog, method 800 can advance to step 880, wherein the schedule component can be configured to deny/prevent deployment of the xApp to the control plane.

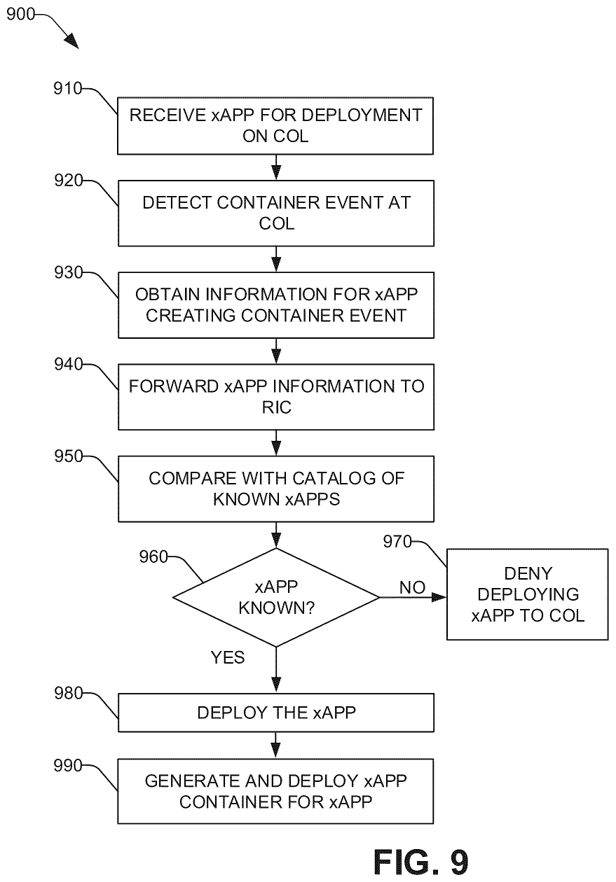

FIG. 9, via flowchart 900, presents a computer-implemented method for securely deploying an xApp on a RAN, in accordance with an embodiment.

At 910, an xApp can be deployed directly to a container orchestration layer (e.g., COL 132).

At 920, as part of deploying the xApp at the container orchestration layer, a control plane component (e.g., control plane component 410) can be configured to deploy the xApp as a container (e.g., xApp container 480) on the container orchestration layer. A container event tracker (e.g., container event tracker 420) can be configured to detect a container event (e.g., event 425A-n) associated with/pertaining to an attempted creation of the container. A container event at the control plane may result from a malicious xApp being deployed directly at the control plane.

At 930, the container event tracker can be further configured to obtain container event information (e.g., descriptor information 116A-n, container deployment information 145A-n, and suchlike) regarding the xApp attempting to be deployed at the control plane and/or information regarding container creation event.

At 940, the container event tracker can be further configured to forward the container event information to a schedule component (e.g., schedule component 138) operating at a RIC (e.g., RIC 130).

At 950, the container event information can be compared by the schedule component with a catalog (e.g., xApp catalog 133), wherein the catalog can comprise a set of xApps that have been reviewed by a hardener (e.g., hardener 135).

At 960, in the event of a determination by the schedule component that NO, the container event information (and the xApp associated therewith) does not match with the catalog information (e.g., the xApp is unknown to the schedule component as the xApp has not been previously reviewed, such as did not undergo parameter enforcement at the onboarding stage), method 900 can advance to step 970, whereupon, the schedule component can be configured to deny deployment, to the control plane, of the xApp generating the container event.

At 970, in the event of a determination by the schedule component that, YES, the container event information (and the xApp associated therewith) does match with xApp information in the catalog information (e.g., the xApp is known to the schedule component as the xApp has been previously reviewed by the hardener, and accordingly, did undergo parameter enforcement at the onboarding stage), method 900 can advance to step 980, whereupon, the schedule component can be configured to allow deployment, to the control plane, of the xApp generating the container event.

At 990, the xApp can be deployed on the container orchestration layer, wherein, as a function of deploying the xApp on the container orchestration layer, the xApp can be deployed as an xApp container (e.g., xApp container 480A-n) at a worker node (e.g., worker node 485A-n) in the container orchestration layer.

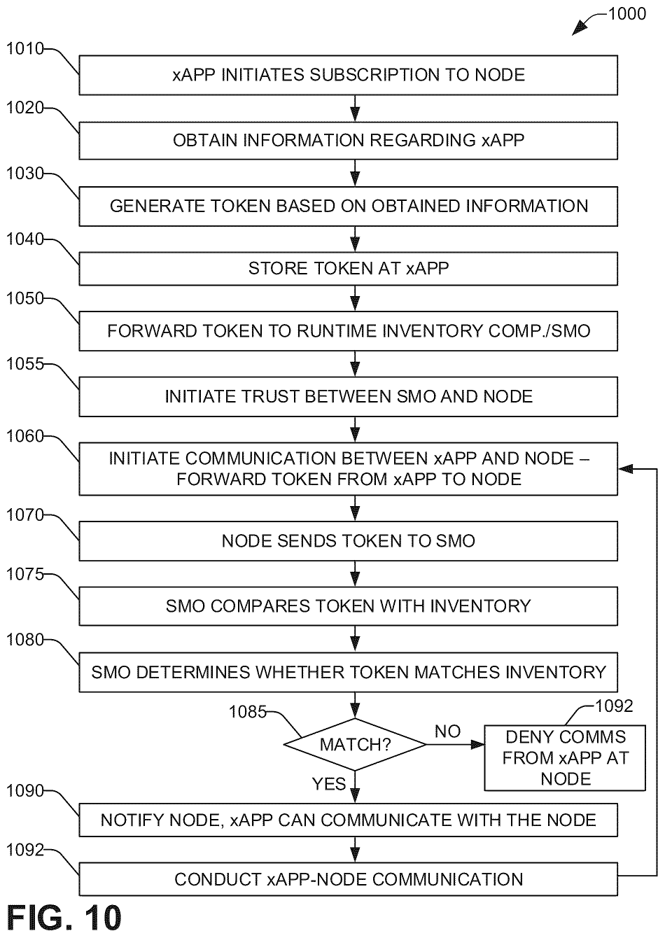

FIG. 10, via flowchart 1000, presents a computer-implemented method for initiating secure xApp-E2Node communications for an xApp deployed on a RAN, in accordance with an embodiment.

At 1010, initiation of secure communication between an xApp/container application and a node can be implemented. As previously described, an xApp container is created at a container orchestration layer (e.g., COL 132) when a containerized xApp is deployed.

At 1020, a security component (e.g., security component 139) at the container orchestration layer can be configured to obtain information (e.g., descriptor 116A-n, container deployment information 145A-n) from a subscription manager component (e.g., subscription manager 510) and from xApp deployer/schedule component (e.g., xApp deployer 137 and schedule component 138).

At 1030, the security component can be further configured to generate a token (e.g., a token 125A-n), wherein the token can include information regarding the xApp, the container, the node (e.g., node 140A-n). Information in the token can include any suitable information/data to enable subsequent verification of an xApp container and the node.

At 1040, the security component can be configured to provide the token to the xApp/xApp container, wherein the token can be stored at the xApp/container (e.g., in a portion of the xApp or xApp container).

At 1050, the security component can be further configured to forward the token to a runtime inventory component (e.g., runtime inventory component 122) operating at the SMO (e.g., SMO 120). In an embodiment, the SMO/runtime inventory component can be configured to maintain a list/inventory of various components, e.g., xApps, xApp containers, nodes, etc., operating on the RAN (e.g., in runtime inventory 123A-n). Accordingly, the SMO/runtime inventory component can be configured to determine whether respective operations, e.g., xApp-E2node communications are being initiated by a known/secure xApp.

At 1055, during creation/implementation of the node to the RAN, the node and the SMO/runtime inventory component can undergo a trust process, such that the node is known to the SMO/runtime inventory component and operates in accordance with one or more operational requirements of the SMO/runtime inventory component.

At 1060, the xApp/xApp container can be configured to initiate communication with the required node. As part of initiating communication, the xApp can forward the token to the node. The xApp/xApp container can forward the token to the node every time the xApp/xApp container attempts to communicate with the node.

At 1070, the node can be configured to forward the token to the SMO/runtime inventory component.

At 1075, the runtime inventory component can be configured to compare the runtime list/inventory of various components with the content of the token.

At 1080, the runtime inventory component can be further configured to determine whether the content of the token matches with the known components in the runtime list/inventory.

At 1085, in response to a determination by the runtime inventory component that YES, the content of the token matches with the known components, e.g., the xApp (e.g., xApp 115A) have been previously entered in the runtime inventory as requiring implementation/communication with the node (e.g., node 140A), method 1000 can advance to step 1090, whereupon a notification (e.g., in communication 197A-n) can be generated and transmitted to the node, confirming the xApp can communicate with the node. Method 1000 can further advance to step 1092, whereupon an xApp-E2Node communication (e.g., communication 550A) is conducted between the xApp/xApp container and the node. As previously mentioned, each time the xApp/xApp container requires to initiate communications with the node, steps 1060-1095 can be performed.

At 1085, in response to a determination by the runtime inventory component that NO, the content of the token does not match with the known components, etc., in the runtime inventory, method 1000 can advance to step 1095, whereupon a notification (e.g., in communication 197A-n) can be generated and transmitted to the node preventing the xApp communicating with the node.

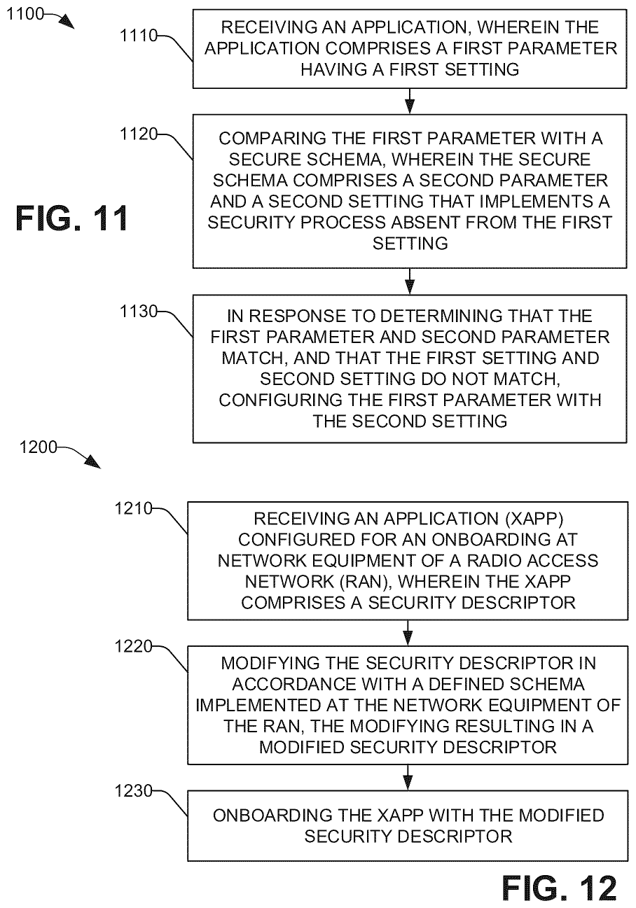

FIG. 11 illustrates a block flow diagram for a system 1100 associated with onboarding, deploying, and/or subscribing xApps on a RAN, in accordance with one or more embodiments presented herein. At 1110, the process 1100 can comprise a system, comprising at least one processor (e.g., processor 182), and a memory (e.g., memory 184) coupled to the at least one processor and having instructions stored thereon, wherein, in response to the at least one processor executing the instructions, the instructions facilitate performance of operations, comprising receiving (e.g., at hardener 135) an application (e.g., an xApp 115A-n), wherein the application comprises a first parameter (e.g., parameter 118A-n) having a first setting (e.g., setting 119A-n). At 1120, the process 1100 can further comprise comparing (e.g., by hardener 135) the first parameter with a secure schema (e.g., schema 136A-n), wherein the secure schema comprises a second parameter (e.g., parameter 161A-n) and a second setting (e.g., setting 162A-n) that implements a security process absent from the first setting. At 1130, the process 1100 can further comprise, in response to determining that the first parameter and second parameter match, and that the first setting and second setting do not match, configuring (by hardener 135) the first parameter with the second setting.

FIG. 12 illustrates a block flow diagram for a process 1200 associated with securely implementing xApps on a RAN, in accordance with one or more embodiments presented herein. At 1210, the process 1200 can comprise receiving, by a device (e.g., hardener 135) comprising at least one processer, an application (xApp 115A-n) configured for an onboarding at network equipment of a radio access network (RAN 110), wherein the xApp comprises a security descriptor (e.g., descriptor 116). At 1220, the process 1200 can further comprise modifying, by the device, the security descriptor in accordance with a defined schema (e.g., schema 136A-n) implemented at the network equipment of the RAN, the modifying resulting in a modified security descriptor (e.g., one or both of parameters 161A-n/settings 162A-n are applied). At 1230, the process 1300 can further comprise onboarding, by the device, the xApp with the modified security descriptor.

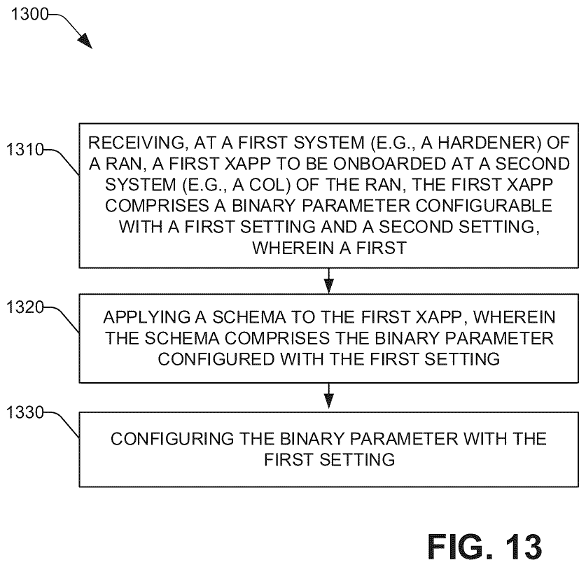

FIG. 13 illustrates a block flow diagram for a process 1300 associated with onboarding, deploying, and/or subscribing xApps on a RAN, in accordance with one or more embodiments presented herein. At 1310, the process 1300 can be performed by a computer program product stored on a non-transitory computer-readable medium and comprising machine-executable instructions, wherein, in response to being executed, the machine-executable instructions cause a first system (e.g., hardener 135) that is part of a RAN (e.g., RAN 110) to perform operations, wherein the process 1300 can comprise receiving a first xApp (e.g., xApp 115A-n) to be onboarded at a second system (e.g., a COL 132) of the RAN, the first xApp comprises a binary parameter (e.g., parameter 118A) configurable with a first setting (e.g., setting 119A) and a second setting (e.g., setting 119B). At 1320, the process 1300 can further comprise applying a schema (e.g., schema 136A-n) to the first xApp, wherein the schema comprises the binary parameter (e.g., parameter 161A comparable to parameter 118A) configured with the first setting (e.g., setting 162A which can be the same as setting 119A). At 1330, the process 1300 can further comprise configuring the binary parameter (e.g., parameter 161A/parameter 118A) with the first setting (e.g., setting 162A/119A).

### Application/Implementation of AI & ML

As mentioned, the various embodiments presented herein can utilize various AI/ML model/technology/technique/architecture (e.g., process component 193 implementing processes 194A-n). AI/ML technologies and techniques can be configured to determine information, make inferences, predictions, etc., regarding onboarding, deployment, and/or subscription of xApps 115A-n (and xApps 107A-n) securely on RAN 110.

Processes 194A-n can include AI, ML, and reasoning techniques/technologies that employ probabilistic and/or statistical-based analysis to prognose or infer an action that an entity desires to be automatically performed for carrying out various aspects thereof, e.g., securely onboarding/deploying/subscribing xApps 115A-n, and further detecting malicious xApps 107A-n, on RAN 110, and suchlike, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., securely onboarding/deploying/subscribing xApps 115A-n, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 193. Thus, the classifier(s) can be used to automatically learn and perform a number of functions, including but not limited to determining according to predetermined criteria, e.g., determining implementation of a benign xApp 115A-n versus a malicious xApp 107A-n, and suchlike.

In an example embodiment, processes 194A-n can be trained/fine-tuned with previously obtained/generated data (e.g., in historical data 195A-n, previously implemented xApps 115A-n/107A-n, schema 136A-n, descriptors 116A-n, deployment configuration 145A-n, etc.). Fine-tuning of a process 194A-n can comprise application, to processes 194A-n, of previously identified xApps 115A-n that were securely implemented at RAN 110 and prior xApps 107A-n that had one or more malicious effects on operation of RAN 110, and suchlike. Processes 194A-n can be correspondingly adjusted by the ability of the processes 194A-n (process component 193, and any associated component across RAN 110 utilizing processes 194A-n) to successfully/or unsuccessfully determine implementation of a benign xApp 115A-n and/or a malicious xApp 107A-n. For example, weightings in the process 194A-n are adjusted by application of the ability to accurately determine an xApp 115A-n that can be configured for onboarding, etc., on RAN 110 versus an xApp 107A-n that is configured to maliciously affect operation of RAN 110, and suchlike. During training, prior decisions, prior observations, determinations, etc., can be applied to the processes 194A-n, enabling the processes 194A-n to be trained regarding securely implementing a benign xApp 115A-n and/or preventing a malicious xApp 107A-n being onboarded, etc., on RAN 110. Accordingly, when new information is provided (e.g., processing of subsequent xApps 115A-n, malicious xApps 107A-n, configuring schema 136A-n, and suchlike), processes 194A-n can be retrained accordingly.

In an example, processes 194A-n can be configured to be implemented by the hardener 135 to assist with determining whether a descriptor 116A-n, and included parameters 118A-n and 119A-n, has a configuration for secure onboarding, etc., on RAN 110. Processes 194A-n can be utilized to review prior xApps 115A-n, xApp containers 480A-n, and malicious apps 107A-n, to determine, in the event of a previously implemented xApp 115A-n, xApp container 480A-n, or malicious xApp 107A-n caused a security breach, operational failure, etc., of RAN 110, what was the content of descriptors 116A-n and deployment/runtime configuration 145A-n that (a) enabled the xApp 115A-n, xApp container 480A-n, or malicious xApp 107A-n to be onboarded, etc., and further, the damage/action caused by the respective parameter 118A-n/setting 119A-n and/or parameters 146A-n/settings 147A-n. Accordingly, the processes 194A-n can be applied to assist in generation of a schema 136A-n configured to ensure secure onboarding, deployment, and/or subscription of an xApp 115A-n/xApp container 480A-n.

In another example, process component 193 and processes 194A-n can be configured, in conjunction with, e.g., container tracker component 420, to analyze respective events 425A-n to determine events relating to deployment of an xApp container 480A-n on the COL 132 that are indicative of a malicious application 107A-n is being deployed at any of the control plane 410, COL 132, worker node 485A-n, generating an xApp container 480A-n, and suchlike. Accordingly, the one or more events 425A-n can be updated to reflect knowledge gained regarding deployment of a malicious xApp 107A-n on COL 132.

In a further example, process component 193 and processes 194A-n can be configured, in conjunction with, e.g., runtime inventory component 122, to identify activity of a malicious xApp 107A-n in establishing communications and subsequent activity with a node 140A-n.

In an example, the hardener component 135 can be further configured to adjust, in conjunction with process component 193 and processes 194A-n, the schema 136A-n to improve the ability for implementation of schema 136A-n to improve the secure onboarding, etc., of an xApp 115A-n and prevent onboarding of a malicious xApp 107A-n.

It is to be appreciated that the various processes 194A-n and operations presented herein are simply examples of respective AI and ML operations and techniques, and any suitable technology can be utilized in accordance with the various embodiments presented herein. In an example embodiment, process component 193/processes 194A-n can be applied to any of previously implemented xApps 115A-n/107A-n, schema 136A-n, descriptors 116A-n, deployment configuration 145A-n, in historical data 195A-n, and suchlike. Wherein, process component 193/processes 194A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of RAN 110 and included/associated components, with processes 194A-n, enables natural language processing (NLP) (e.g., utilizing vectors) to determine whether a benign xApp 115A-n is being securely onboarded, etc., implemented on RAN 110, or an attempt is being made to onboard a malicious xApp 107A-n. is attempted, wherein the determined benign or malicious onboarding can be presented on HMI 186/screen 187A-n for review, and further, for use by hardener component 135, schedule component 138, runtime inventory component 122, security component 139, and suchlike.

During application of processes 194A-n, vector representations Vin can be applied to any of prior and current xApps 115A-n, xApps 107A-n, schema 136A-n, event s425A-n, tokens 125A-n, etc., such that vector similarity operations (e.g., vector clustering/distancing) can be applied to securely onboard, etc., a benign xApp 115A-n while denying/detecting onboarding of a malicious xApp 107A-n, from the accrued prior knowledge regarding prior implementation of xApps 115A-n and/or 107A-n, per historical data 195A-n, schema 136A-n, and suchlike. The degree of similarity (e.g., via similarity indexes S₁₋ₙ) between respective information can be determined, for example, based on a threshold reflecting a proximity of a first vector generated from information pertaining to onboarding, etc., regarding a first known secure xApp (e.g., xApp 115A-n) and a second, malicious xApp (e.g., xApp 107A-n), enabling differentiation between benign xApps 115A-n and malicious xApps 107A-n, e.g., via vector quantization, of xApps 115A-n and 107A-n in historical data 195A-n.

### 9. Example Environments of Use

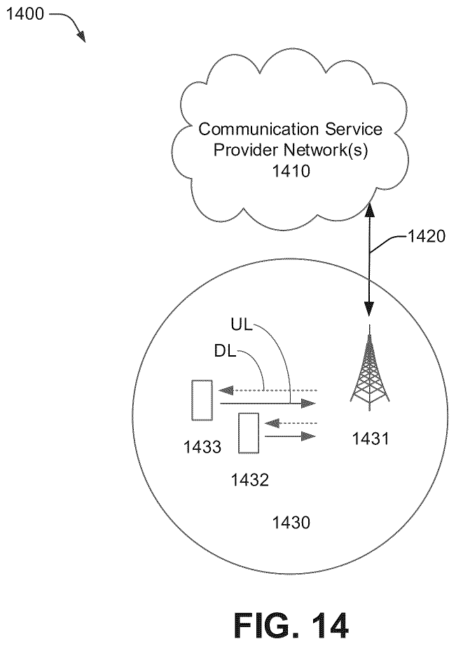

FIG. 14 illustrates an example wireless communication system 1400, in accordance with one or more embodiments described herein. The example wireless communication system 1400 comprises communication service provider network(s) 1410, a network node 1431, and user equipment (UEs) 1432, 1433. A backhaul link 1420 connects the communication service provider network(s) 1410 and the network node 1431. The network node 1431 can communicate with UEs 1432, 1433 within its service area 1430. The dashed arrow lines from the network node 1431 to the UEs 1432, 1433 represent downlink (DL) communications to the UEs 1432, 1433. The solid arrow lines from the UEs 1432, 1433 to the network node 1431 represent uplink (UL) communications.

In general, with reference to FIG. 14, the non-limiting term “user equipment” can refer to any type of device that can communicate with network node 1431 in a cellular or mobile communication system 1400. UEs 1432, 1433 can have one or more antenna panels having vertical and horizontal elements. Examples of UEs 1432, 1433 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 1432, 1433 can also comprise IoT devices that communicate wirelessly.

In various embodiments, system 1400 comprises communication service provider network(s) 1410 serviced by one or more wireless communication network providers. Communication service provider network(s) 1410 can comprise a “core network”. In example embodiments, UEs 1432, 1433 can be communicatively coupled to the communication service provider network(s) 1410 via a network node 1431. The network node 1431 can communicate with UEs 1432, 1433, thus providing connectivity between the UEs 1432, 1433 and the wider cellular network. The UEs 1432, 1433 can send transmission type recommendation data to the network node 1431. The transmission type recommendation data can comprise a recommendation to transmit data via a closed loop multiple input multiple output (MIMO) mode and/or a rank-1 precoder mode.

Network node 1431 can have a cabinet and other protected enclosures, computing devices, an antenna mast, and multiple antennas for performing various transmission operations (e.g., MIMO operations) and for directing/steering signal beams. Network node 1431 can comprise one or more base station devices which implement features of the network node. Network nodes can serve several cells, depending on the configuration and type of antenna. In example embodiments, UEs 1432, 1433 can send and/or receive communication data via wireless links to the network node 1431.

Communication service provider networks 1410 can facilitate providing wireless communication services to UEs 1432, 1433 via the network node 1431 and/or various additional network devices (not shown) included in the one or more communication service provider networks 1410. The one or more communication service provider networks 1410 can comprise various types of disparate networks, including but not limited to: cellular networks, femto networks, picocell networks, microcell networks, internet protocol (IP) networks Wi-Fi service networks, broadband service network, enterprise networks, cloud-based networks, millimeter wave networks and the like. For example, in at least one implementation, system 1400 can be or comprise a large-scale wireless communication network that spans various geographic areas. According to this implementation, the one or more communication service provider networks 1410 can be or comprise the wireless communication network and/or various additional devices and components of the wireless communication network (e.g., additional network devices and cell, additional UEs, network server devices, etc.).

The network node 1431 can be connected to the one or more communication service provider networks 1410 via one or more backhaul links 1420. The one or more backhaul links 1420 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 1420 can also comprise wireless link components, such as but not limited to, line-of-sight (LOS) or non-LOS links which can comprise terrestrial air-interfaces or deep space links (e.g., satellite communication links for navigation). Backhaul links 1420 can be implemented via a “transport network” in some embodiments. In another embodiment, network node 1431 can be part of an integrated access and backhaul network. This may allow easier deployment of a dense network of self-backhauled 5G cells in a more integrated manner by building upon many of the control and data channels/procedures defined for providing access to UEs 1432, 1433.

Wireless communication system 1400 can employ various cellular systems, technologies, and modulation modes to facilitate wireless radio communications between devices (e.g., the UEs 1432, 1433 and the network node 1431). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 1400 can operate in accordance with any 5G, next generation communication technology, or existing communication technologies, various examples of which are listed supra. In this regard, various features and functionalities of system 1400 are applicable where the devices (e.g., the UEs 1432, 1433 and the network node 1431) of system 1400 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 1400 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example, several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 9 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

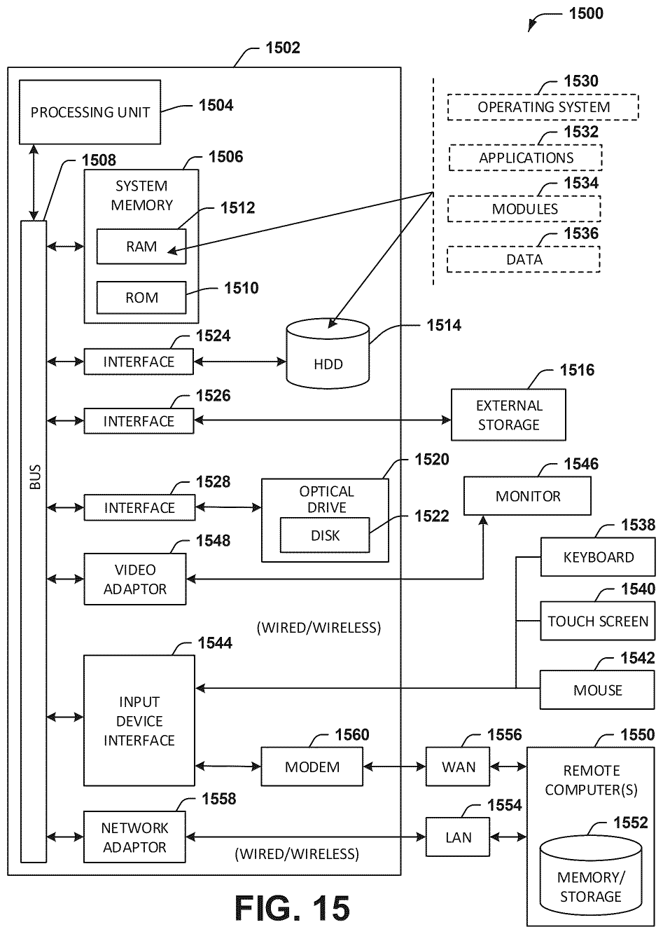

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 15, the example environment 1500 for implementing various embodiments of the aspects described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors and may include a cache memory. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1550 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid-state drive (SSD) could be used in addition to, or in place of, an HDD 1514. The HDD 1514, external storage device(s) 1516 and optical disk drive 1550 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can comprise a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities. The terms “set” and “group” are used interchangeably herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G, O-RAN, or other generation networks, the disclosed aspects are not limited to 5G or O-RAN implementations, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory coupled to the at least one processor and having instructions stored thereon, wherein, in response to the at least one processor executing the instructions, the instructions facilitate performance of operations, comprising:
receiving an application, wherein the application comprises a first parameter having a first setting;
comparing the first parameter with a secure schema, wherein the secure schema comprises a second parameter and a second setting that implements a security process absent from the first setting; and
in response to determining that the first parameter and second parameter match, and that the first setting and second setting do not match, configuring the first parameter with the second setting.

2. The system of claim 1, wherein the operations further comprise:
in response to determining that the first parameter and the second parameter do not match, adding the second parameter to the application, and wherein the second parameter is added with the second setting.

3. The system of claim 1, wherein the first parameter and the first setting are included in descriptor content of the application.

4. The system of claim 1, wherein the application is a containerized application (xApp) deployable via network equipment of a radio access network (RAN).

5. The system of claim 4, wherein the comparing is performed during onboarding of the application to the network equipment of the RAN.

6. The system of claim 5, wherein the operations further comprise:
storing the descriptor content of the application and a container parameter defined for the application in a catalog, wherein the catalog comprises a set of applications, and wherein the set of applications have been previously compared with the secure schema.

7. The system of claim 6, wherein the operations further comprise:
deploying the application to a container orchestration layer (COL);
confirming that the application appears in the catalog; and
in response to determining that the application does appear in the catalog, deploying the application to the COL, wherein deploying the application comprises creating a container at the COL, and wherein the container is configured based on the container parameter defined for the application.

8. The system of claim 7, wherein the operations further comprise, in response to determining that the application does not appear in the catalog, denying deployment of the application to the COL.

9. The system of claim 8, wherein the operations further comprise:
capturing a container creation event at the COL;
identifying an application creating the container event;
comparing the application with the catalog; and
in response to the application being determined not to be in the catalog, denying deployment of the application.

10. The system of claim 9, wherein the operations further comprise:
generating a token, wherein the token comprises first information identifying the application paired with second information identifying a node, and wherein the application is attempting to establish communication with the node;
comparing the token with a runtime inventory, wherein the runtime inventory comprises a list of applications approved for deployment on the network equipment of the RAN; and
in response to determining that the application and node paired in the token match a pairing of the application and the node in the runtime inventory, enabling communication between the application and the node.

11. The system of claim 10, wherein the operations further comprise, in response to determining that the application and node paired in the token do not match a pairing of the application and the node in the runtime inventory, denying communication between the application and the node.

12. A computer-implemented method comprising:
receiving, by a device comprising at least one processer, an application (xApp) configured for an onboarding at network equipment of a radio access network (RAN), wherein the xApp comprises a security descriptor;
modifying, by the device, the security descriptor in accordance with a defined schema implemented at the network equipment of the RAN, the modifying resulting in a modified security descriptor; and
onboarding, by the device, the xApp with the modified security descriptor.

13. The computer-implemented method of claim 12, wherein the xApp is a containerized xApp configured to be deployed on a container orchestration layer (COL) located within the network equipment of the RAN.

14. The computer-implemented method of claim 13, wherein the security descriptor comprises an xApp container parameter.

15. The computer-implemented method of claim 14, further comprising, signing, by the device, the xApp with a signature, wherein the signature indicates the xApp has been modified with the defined schema.

16. The computer-implemented method of claim 15, further comprising:
receiving, by the device, the xApp for deployment at the COL;
determining, by the device, the xApp comprises the signature indicating the xApp has been modified with the defined schema; and
deploying, by the device, the xApp at a worker node of the COL, wherein the worker node is configured in accordance with the xApp container parameter.

17. A computer program product stored on a non-transitory computer-readable medium and comprising machine-executable instructions, wherein, in response to being executed, the machine-executable instructions cause a first system that is part of a radio access network (RAN) to perform operations, comprising:
receiving a first xApp to be onboarded at a second system of the RAN, the first xApp comprises a binary parameter configurable with a first setting and a second setting;
applying a schema to the first xApp, wherein the schema comprises the binary parameter configured with the first setting; and
configuring the binary parameter with the first setting.

18. The computer program product according to claim 17, wherein:
the first xApp is received with an initial scope of implementation on an O-cloud platform:
the first setting limits scope of implementation of the first xApp on the O-cloud platform to the initial scope of implementation; and
the second setting configures the first xApp with unlimited scope of implementation of the xApp on the O-cloud platform.

19. The computer program product according to claim 17, wherein the operations further comprise:
creating an xApp container on a container orchestration layer (COL), wherein the xApp container is configured in accordance with the binary parameter configured with the first setting.

20. The computer program product according to claim 17, wherein the operations further comprise:
signing the first xApp to indicate that the first xApp has been configured with the binary parameter and the first setting;
detecting a container creation event at a container orchestration layer, wherein the container creation event is initiated by a second xApp;
analyzing the second xApp for a signature indicating that the second xApp has been configured with the binary parameter and the first setting; and
in response to determining the second xApp does not comprise the signature, preventing the second xApp from being onboarded.
